(19) United States
(12) Patent Application Publication
(10) Pub. No.: US 2002/0015097 A1
(43) Pub. Date: Feb. 7, 2002

(54) Lighting control device and method of controlling lighting

(76) Inventors: Christiaan Jacob Martens, Eindhoven (NL); Noel Francois Leopold Bonne, Eindhoven (NL); Hendrik Bijl, Eindhoven (NL)

Correspondence Address: U.S. Philips Corporation, 580 White Plains Road, Tarrytown, NY, 10591, US

(21) Appl. No.: 09/885,700

(22) Filed: Jun. 20, 2001

(30) Foreign Application Priority Data
Jun. 23, 2000 (EP) 00202198.8

(51) Int. Cl. H04N 5/225; H04N 9/04

(52) U.S. Cl. 348/207

(57) ABSTRACT

A lighting arrangement comprising a sensor which is capable of measuring electromagnetic radiation, preferably visible light as well as infrared light, in a room, and comprising control means for controlling the lighting in the room in dependence upon the measured radiation, the sensor comprising a video sensor, such as a CCD (Charged Coupled Device) sensor, which is capable of producing an electronic image of the room.

The invention relates to a lighting control device comprising a sensor, which is capable of measuring electromagnetic radiation in a room, and control means which are capable of controlling the lighting in the room in response to the measured radiation values.

In this connection, “electromagnetic radiation” is to be taken to mean, in particular, visible light and near infrared light. It is well known to measure and control the light level in an office by means of a sensor comprising a single photocell which is mounted at the ceiling and monitors the workplace(s) at a specific observation angle. A drawback of the known sensor resides in that it measures an integral light intensity in the observation range. If windows are situated, partly or entirely, within the observation range, then the amount of light reaching the sensor through the window (for example originating from reflections of a parking space outside the building), may become a dominant factor in the overall output signal of the light sensor. As a result thereof, it may become too dark inside due to the action of the light control. This possible disturbance depends to a substantial degree on the weather conditions and the brightness outside. A similar disturbance may occur if direct sunlight enters through the windows, leading to extremely bright light patches on the window pane, desks or even on the floor. These light patches are almost always situated within the observation range of the sensor.

Apart from a detector which does not have the above-mentioned drawbacks, there is a need for lighting which can be controlled by means of a remote control. In addition, there is a need for lighting which is controlled automatically in dependence on the presence of people. For this purpose, in the known sensor, respectively, an infrared cell and a motion detector must be installed next to the photocell.

It is an object of the invention to provide an efficient, practical and accurate lighting control device, which is capable of carrying out a number of the above functions at low costs and which leads to a reduction of the drawbacks of the known systems.

To achieve this, the sensor comprises a video sensor, for example a CCD (Charged Coupled Device) sensor, which is capable of producing an electronic (video) image of the room. Such a sensor is frequently used in video cameras and, as a result of the large numbers, can be economically manufactured. The electronic image can be analyzed by the control means, by means of which the lighting in the room can be accurately adjusted.

Preferably, the sensor and the control means can suitably be used to control the lighting in response to the measured radiation values of both visible light and infrared radiation. This enables, for example, the lighting to be controlled also by means of an infrared remote control which is directed at the sensor. For this purpose, preferably, the control means can respond to signals emitted by a remote control. The device is also capable of detecting the presence of human beings, by means of infrared detection, if it is dark in the room. For this purpose, for example, a near infrared light source should be present in the space, to which the video sensor is susceptible.

Preferably, the control means are capable of controlling the lighting in response to the contrast between the values of the image. The control means preferably are also capable of controlling the lighting in response to the radiation values of visible light in predetermined parts of the image, so that parts disturbing the image, such as parts of the room that are brightly lit by the sun, can be ignored. These parts can be determined either automatically or they can be entered by hand.

Preferably, the control means are capable of controlling the lighting in response to the color temperature values of the image. By virtue thereof, in conjunction with a luminaire by means of which the color temperature can be varied, it becomes possible to bring about a constant color temperature or, conversely, dependent upon the objective, different color temperatures of the lighting can be adjusted.

Preferably, the control means include motion detection means, which enable the lighting to be switched on when a person enters the room. More preferably, the control means comprise object recognition means which can recognize a specific object in the CCD video image, so that also non-moving objects (for example motionless people) are observed.

The invention further relates to a method of controlling the lighting in a room, wherein the electromagnetic radiation in a room is measured by means of a sensor, the lighting in the room is controlled, by means of control means, in response to the measured radiation values, and the electromagnetic radiation is measured by a CCD (Charged Coupled Device) sensor producing an electronic image of the room.

These and other aspects of the invention will be apparent from and elucidated with reference to the embodiment(s) described hereinafter.

In the drawings:

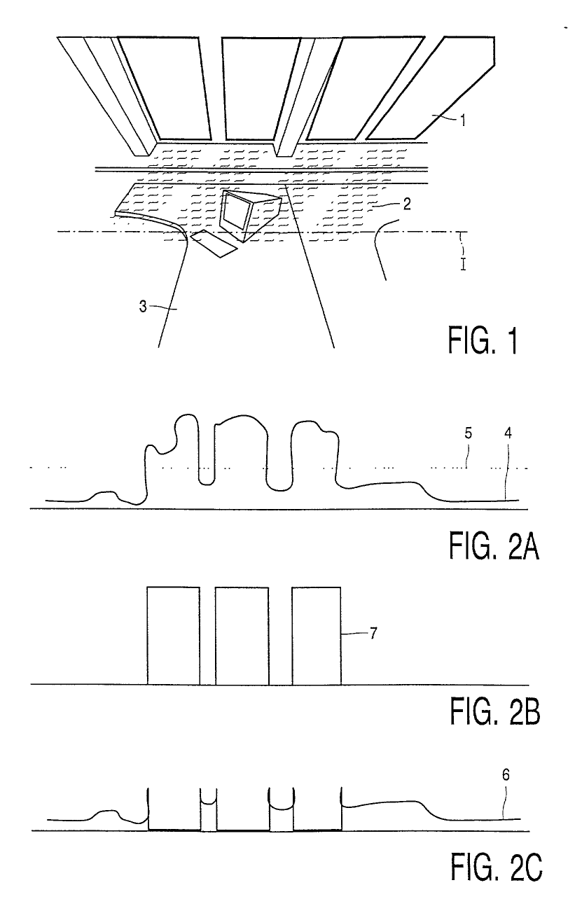

FIG. 1 shows a video image observed by a CCD sensor;

FIG. 2 shows, respectively, (A) the video signal of a video line of the video image shown in FIG. 1, (B) a comparator output associated with the video signal and (C) the resulting, processed video signal;

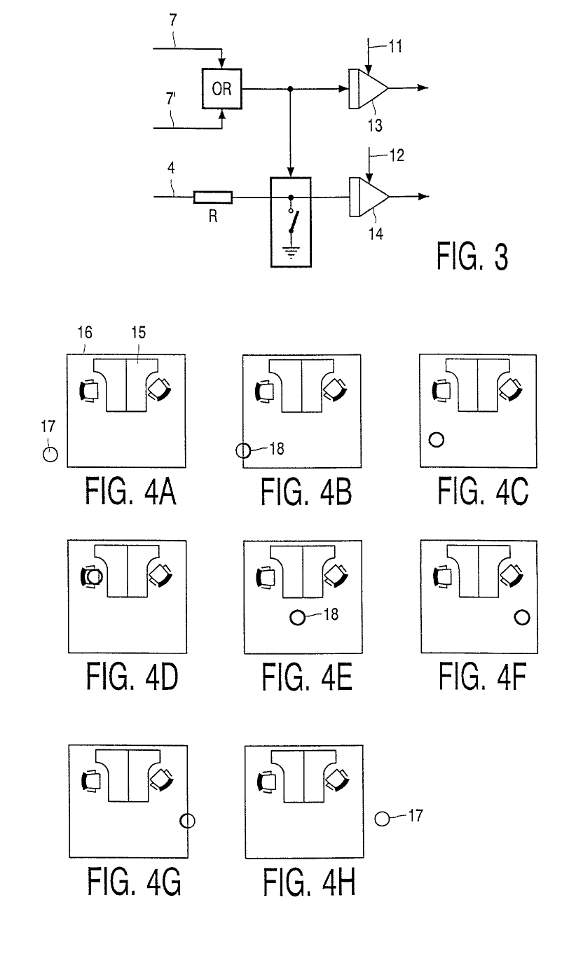

FIG. 3 shows a processing diagram of the signals of FIG. 2; and

FIGS. 4A-4H show a series of video images illustrating the object recognition process within the scope of the invention.

FIG. 1 shows an image as can be observed by a CCD sensor which is provided with a lens (the CCD sensor can thus also be referred to as a CCD camera), which CCD sensor, in conjunction with control means, forms part of a lighting control device and is mounted at the ceiling. The lighting control device is connected to the various luminaires situated in the room, and is capable of adjusting the intensity with which these luminaires illuminate the different spots in the room. The object is to achieve the best possible illuminance at the workplaces. By means of a CCD camera, in principle, shortcomings of the sensor discussed hereinabove can be eliminated by:

Static Masking

As the positions of the windows 1 in the image of the camera are known, the light observed in these positions can be excluded from the computation algorithm carried out by the control means. This can be manually adjusted or it can be an automatic (self-learning) process. At moments when the office lighting is not burning, for example, images are collected and an image is composed, possibly by means of contrast-improving techniques, of the positions where a high brightness is observed. This image is frozen and used, at a later stage, in the data interpretation process to remove the disturbing positions of the windows 1 (both the positions/solid angles and the light impressions thereof are ignored in the computation). Such a keying technique is also used, for example, in the color television technique where it is commonly referred to as “chroma keying” (color information keying; generally blue is chosen). Here, one type of information is substituted with another type of information, as is the case in the images of the weather forecaster: a blue background is substituted with the weather chart.

Masking for Light Intensity

Direct sunlight entering through the windows 1 will lead to a light intensity in the paths 2 on the desk 3 where the sunlight is incident, which is much higher than the light intensity outside these paths. Upon reading out the image produced by the camera, a substantial surge in the video output signal 4 of video line I will be found exactly at the edges of these sunlight paths 2 (see FIG. 2). If this video output signal 4 exceeds a predetermined value 5, also these positions and light impressions can be keyed from the information flow, resulting in a processed output signal 6, as shown in FIG. 2.

Such a technique is employed in, for example, “Closed Circuit Television” for traffic control purposes. In this manner, overshoot originating from, for example, headlights can be suppressed. Very bright lights are shown in black. In said field of application, the technique is referred to as “Peak White Invert”. Thus, it can be readily understood that the disturbance of the light perception caused by a person in a very white shirt being visible on the image can also be eliminated.

The combination of the techniques described hereinabove can give a fairly good impression of the prevailing light values at the normal workplaces, because the most disturbing factors have been eliminated.

FIG. 3 diagrammatically shows how this can be achieved. The comparator output 7 of the frozen image of the windows 1 as well as the comparator output 7′ of the “live” image are jointly passed through an OR circuit, and the output is used to key the excessively bright lights from the “live” image signal 4 produced by the camera. If the resets 11, 12 of the integrators 13, 14 take place at the beginning of the image, then the total light value (without the bright lights) of the image will be present on integrator 14 at the end of the image duration, and the image duration over which averaging should not take place is present on integrator 13. The average light value (without bright lights) thus is: E_{averaged}=(Eₜₒₜₐₗ)/(image duration−Tₘᵢₙ).

The daylight contribution, however, is not uniform throughout the office. In the lighting technique this phenomenon is referred to as the daylight factor. This factor describes a certain daylight reduction curve. Close to the window 1, the daylight contribution is larger, and it decreases as the distance to the window 1 increases. This is a non-linear curve. This daylight factor also depends on the season. By dividing the image of the sensor into, for example, two fields, i.e. one close to the window 1 and one at a larger distance from the window 1, which fields must additionally substantially coincide with the individual lighting from two individual rows of luminaires, it is thus possible to slightly compensate for this daylight gradient. Consequently, a camera can drive various control circuits simultaneously. In other words, a plurality of conventional sensors can be replaced by one camera which, in addition, performs better.

Color Recognition

Using a color CCD camera, certain decisions can also be made by using the color content. The information from a color CCD consists, in principle, of three images; one image for red, one image for green and one image for blue. By adding together these three components, using a certain weight factor for each component, an image showing the brightnesses (black-white) is obtained. This image can thus be subjected to the above-described processes.

The sunlight which directly enters the room, however, has a much higher component for red than for the other colors. Consequently, by suitably comparing this red component with the size of the other information, in principle, also the patches of direct sunlight can be recognized and hence an operation which is similar to that described with respect to “masking for light intensity” can be carried out.

Controlling the Color Temperature

A color CCD also makes it possible to pronounce on the prevailing color temperature of the light. This information can thus also be used to build up a control circuit in conjunction with luminaires, whereby the color temperature of the light can be regulated to control the light color temperature. Practical examples of this are: keeping the color temperature constant during dimming, or deliberately controlling a preferred setting of the employee, or imitating a daylight cycle in order to stimulate a higher productivity, etc.

To detect the presence of a person or persons in the office space (in order to switch the light on or off on the basis of this information), hitherto, use has been made of passive infrared detectors, ultrasound detectors or ordinary sound detectors or radar detection. These detection methods are in general use in security systems or automatic door openers. In fact, the detection techniques are all based on changing physical quantities, i.e. on moving objects which, in the former case, must emit heat and, in the latter case, must exhibit a certain absorption of electromagnetic fields (50 to 100 liters of water). The detectors used to automatically switch the light on or off are generally optimized for this application (mounted at the ceiling; the right sensitivity to detect people in a seated position which only move their hands).

In the currently used light switching systems and light control systems, where the artificial light should only be on when people are present in the room and, simultaneously, the amount of artificial light should be controllable in the case of daylight entering the room, it will be necessary to apply a combination of sensors (a presence sensor and a light sensor).

Presence Detection by Means of a CCD Camera

The use of video cameras for security reasons is commonly known. The fact that this video information can also be used to automatically generate an alarm is less well known, although in the past it was frequently applied to guard, for example, unmanned aircraft stationed at the apron. The technique used in this case is: a frame is drawn around the object to be guarded. The video content of the previous image (or previous images) at the location of this frame is compared with the new image. A clear difference between these images means that there is something or someone trying to penetrate this frame, as a result of which an alarm is generated. Such a technique can also be used to switch the lighting.

An example hereof is shown in FIG. 4. A number of workplaces 15 are within the range of the CCD camera, which is mounted at the ceiling. Frames 16 are drawn around the separately switchable lighting groups. If a person 17 enters such a frame, the video content will change at the location where the person 17 enters this frame. At the location of this change, a contour line 18 is drawn. If the person 17 is completely inside the frame 16, there is a closed contour line 18 which encloses a certain surface area. If this surface area is sufficiently large, it may be assumed that this surface area denotes a person. The light will switch on. As long as this contour 18 (or a number of contours 18) is situated within this frame 16, the light remains on, even if the person 17 involved has fallen asleep behind his desk. In this example, the light switches on at image C and switches off at image G. Other well-known methods of object recognition by means of camera images can also be used of course.

It will be obvious that this type of image processing requires a certain amount of light, because without light there is no image. In order to be able to produce an image in pitch-darkness, use can be made of infrared-emitting diodes (LEDs) or of other infrared light sources. This is a well-known technique employed in security cameras, where a complete array of IR LEDs is sometimes arranged around the lens of the camera. These light sources do not have to issue light continuously, one flash per image scan is sufficient. Obviously, in these cases the camera must be sensitive to near infrared light (850 or 950 nanometers).

If present, such IR-LEDs can also be used for other tasks, such as the emission of infrared remote control codes or other data traffic. For remote control in general use can be made of various techniques. In the very beginning of remote control for television receivers, use was made of ultrasonic sound signals. Currently, most remote control devices for television receivers are based on infrared light. The already existing technology of radio frequency remote control has only just become available because international legislation regarding the use of these radio frequencies has been recently adapted. Both techniques require the use of fairly complex and extensive codes, because it should be possible to use these remote controls for various applications simultaneously in the same room. For example for television, video recorder, video projector, audio, awning and also for lighting. For radio-frequency applications, this space may even be very large because this radiation can also pass through walls. The range varies from 50 to 100 meters.

In the applied infrared protocol (Philips-standard, RC-5), different code blocks are assigned to all these different applications, and, in the blocks used by Philips Lighting Controls, sub-blocks are defined in order to be able to individually operate the different groups of lighting in a large room. The digital message thus contains information indicating for which system this message is intended as well as information indicating what should be done. Currently, to operate the lighting in offices, use is made of a division into eight sub-groups with fifteen independent commands per group.

Remote Control by Means of the CCD Camera

The scan frequency of a video camera is generally related to the electric mains frequency in order to preclude interference with the intensity variations of the light sources (lamps). For Europe this means 20 milliseconds per frame or 40 milliseconds per image. Consequently, the sample rate that can be achieved with a CCD camera is very low while, for ergonomic reasons, it must be possible to interpret a message within 250 milliseconds. It can be concluded thus that the current RC-5 protocol cannot be processed using a standard CCD camera. The RC-5 protocol, however, has too much “overhead” for the camera, since the camera is capable of locating the emitter (or the emission direction of the emitter). From this a substantial part of the meaning of the command can already be inferred.

An emitter mounted near the door only has to be able, in principle, to emit two commands, namely: “light on” and “light off”. The fact that the command “light on” means that in some cases the orientation lighting has to be switched on (so that people can find their way to the workplace) while, in other cases, it means that all lights must be switched on (for example for a cleaning service) is determined by the system by means of other information such as clock information. In the image of the camera, it would thus be possible to define an area (near the door), such that a light phenomenon which is modulated in a certain way can have these meanings when it is observed in said area.

If it is desirable to also assign room temperature functions to this emitter, then only two commands have to be added, namely: “heating on” and “heating off”. Consequently, all in all there are only 4 commands.

For mobile emitters which can be used at the workplace, more possibilities are generally desired, such as: “light situation 1”; “light situation 2”; “light situation 3” and “light off”. If also the awning functions are added: “up”; “stop” and “down”, the total number of commands is seven.

If the camera sees a certain light modulation within a frame comprising the workplace, as already indicated in the example of FIG. 4, then this command is carried out for this workplace. Such a signal taking place outside a frame has no meaning and, consequently, is not carried out.

From the foregoing it can be derived that the number of necessary messages can be very limited actually. A simple 3-of-5 code already enables ten different messages to be conveyed:

5!/(3!*(5−3)!)=10.

Thus, if the message relates to a frame of seven samples, the first one of which must always be a “1”, and subsequently five sample slots, only three of which may contain a “1”, and the seventh sample always is a “0”, then a message can be conveyed in seven samples. This would require maximally 280 milliseconds.

It has been described hereinabove that it could be interesting to provide the CCD camera with IR-LEDs. If the remote control emitters are also provided with a IR receiver, then these emitters can, for example, also be synchronized by the camera or they can be given a different function, or a setting can be changed (for example of the temperature emitter), or the emitter can be questioned (the output of the emitter only has to be “yes” or “no” in this case). This results in many more practical possibilities.

1. A lighting control device comprising a sensor, which is capable of measuring electromagnetic radiation in a room, and control means which are capable of controlling the lighting in the room in response to the measured radiation values, characterized in that the sensor includes a video sensor which is capable of taking an electronic image of the room.

2. A lighting control device as claimed in claim 1, characterized in that the video sensor comprises a CCD (Charged Coupled Device).

3. A lighting control device as claimed in claim 1 or 2, characterized in that the sensor and the control means can suitably be used to control the lighting in response to the measured radiation values of both visible light and infrared radiation.

4. A lighting control device as claimed in claim 1, 2 or 3, characterized in that the control means are capable of controlling the lighting in response to the radiation values of visible light in predetermined parts of the image.

5. A lighting control device as claimed in any one of the preceding claims, characterized in that the control means are capable of controlling the lighting in response to the color temperature values of the image.

6. A lighting control device as claimed in any one of the preceding claims, characterized in that the control means are capable of controlling the lighting in response to the contrast between the values of the image.

7. A lighting control device as claimed in any one of the preceding claims, characterized in that the control means comprise motion detection means.

8. A lighting control device as claimed in any one of the preceding claims, characterized in that the control means comprise object recognition mean s.

9. A lighting control device as claimed in any one of the preceding claims, characterized in that the control means can react to signals emitted by a remote control.

10. A method of controlling the lighting in a room, wherein the electromagnetic radiation in a room is measured by means of a sensor, the lighting in the room is controlled, by means of control means, in response to the measured radiation values, characterized in that the electromagnetic radiation is measured by a CCD (Charged Coupled Device) sensor producing an electronic image of the room.
